(19) United States
(12) Patent Application Publication
(10) Pub. No.: US 2024/0143526 A1
(43) Pub. Date: May 2, 2024

(54) Data processing unit with transparent root complex

(71) Applicant: Mellanox Technologies, Ltd., Yokneam (IL)

(72) Inventors: Liran Liss, Atzmon (IL); Rabia Loulou, Nazareth (IL); Idan Burstein, Akko (IL); Tzuriel Katoa, Tiberias (IL)

(21) Appl. No.: 17/976,909

(22) Filed: Oct. 31, 2022

(51) Int. Cl. G06F 13/28; G06F 13/42

(52) U.S. Cl. CPC G06F 13/28; G06F 13/4221

(57) ABSTRACT

Computing apparatus includes a central processing unit (CPU) and a root complex connected to the CPU and to a first peripheral component bus, which has at least a first downstream port for connection to at least one peripheral device. Switching logic has an upstream port for connection to a second downstream port on a second peripheral component bus of a host computer, and is connected to the root complex so that when a peripheral device is connected to the first downstream port on the first peripheral component bus, the switching logic presents the peripheral device to the host computer in an address space of the second peripheral component bus.

### FIELD OF THE INVENTION

The present invention relates generally to computing systems, and particularly to devices and methods for bridging memory address spaces among computing system components and peripheral devices.

### BACKGROUND

PCI Express® (commonly referred to as PCIe) is a high-speed packet-based peripheral component bus standard, which is used in most current computer motherboards. The PCIe architecture is built around a “root complex,” which connects the central processing unit (CPU) and memory subsystem of the computer to the PCIe interconnect fabric. The root complex has one or more downstream ports, which connect to the upstream ports of PCIe endpoints, switches, or bridges to other PCIe buses. Each PCIe switch has a number of downstream ports, which may likewise connect to upstream ports of other endpoints, switches, or bridges, thus forming a sub-hierarchy within the PCIe fabric.

### SUMMARY

Embodiments of the present invention that are described hereinbelow provide improved apparatus and methods for interconnecting host processors and peripheral devices.

There is therefore provided, in accordance with an embodiment of the invention, computing apparatus, including a central processing unit (CPU) and a root complex connected to the CPU and to a first peripheral component bus, which has at least a first downstream port for connection to at least one peripheral device. Switching logic has an upstream port for connection to a second downstream port on a second peripheral component bus of a host computer, and is connected to the root complex so that when a peripheral device is connected to the first downstream port on the first peripheral component bus, the switching logic presents the peripheral device to the host computer in an address space of the second peripheral component bus.

In a disclosed embodiment, the switching logic includes a virtual switch. Additionally or alternatively, the peripheral device includes a data storage device and/or a network interface controller (NIC).

In some embodiments, the switching logic is to present the peripheral device as a physical function in the address space of the second peripheral component bus. In one embodiment, the peripheral device is to expose a virtual function on the first peripheral component bus, and the switching logic is to present the virtual function as the physical function in the address space of the second peripheral component bus.

Alternatively or additionally, the switching logic is to present the peripheral device as a virtual function in the address space of the second peripheral component bus.

In some embodiments, the address space of the second peripheral component bus is a second address space, and the root complex is to present the peripheral device to the CPU in a first address space of the first peripheral component bus. In a disclosed embodiment, the switching logic is to receive a bus transaction via the upstream port referencing the second address space of the second peripheral component bus and directed to the peripheral device, to translate the bus command to the first address space, and to transmit the translated bus command over the first peripheral component bus.

In one embodiment, the switching logic is to reserve a segment of the address space for a dummy device, to enable hot-plugging of a further peripheral device in the reserved segment.

There is also provided, in accordance with an embodiment of the invention, a method for computing, which includes providing a peripheral device server including a root complex connected to a first peripheral component bus. A peripheral device is connected to a first downstream port on the first peripheral component bus. An upstream port of the peripheral device server is connected to a second downstream port on a second peripheral component bus of a host computer. Using switching logic in the peripheral device server coupled between the upstream port and the first downstream port, the peripheral device is presented to the host computer in an address space of the second peripheral component bus.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a computer system, in accordance with an embodiment of the invention; and

FIGS. 2, 3 and 4 are block diagrams that schematically illustrate methods for interconnection between a host processor and a peripheral device, in accordance with an embodiment of the invention.

### DETAILED DESCRIPTION OF EMBODIMENTS

### Overview

In conventional computer and software architectures, the host computer communicates with peripheral devices via its own, local peripheral component bus, such as a PCIe bus. For this purpose, the host computer includes a root complex, as explained above. The operating system of the host computer defines the peripheral device functions that are available via the bus and assigns each one an address range on the bus, known as a base address register (BAR) in PCIe parlance. Application software running on the host processor can then access the peripheral device functions by writing to and reading from the assigned address ranges. The PCIe bus also permits “hot plugging,” in which devices can be connected to and disconnected from the bus while the computer is running.

In large computer networks, for example in a data center, multiple host computers commonly share the resources of a given peripheral device, such as a network interface controller (NIC), a graphics processing unit (GPU), or a storage device, such as a solid-state disk (SSD). These peripheral devices may be connected to a dedicated server, such as a storage server or “smart NIC,” which distributes the peripheral device services among the host computers. A peripheral device server of this sort is referred to herein, for the sake of simplicity and clarity, as a “data processing unit” (DPU), regardless of the type or types of peripheral devices that are connected to it. The DPU may run software that emulates the functionality of a peripheral device that is attached locally to a host computer, while the peripheral device is accessed through and controlled by the DPU. This sort of software-based emulation is described, for example, in U.S. Patent Application Publication 2022/0309019, whose disclosure is incorporated herein by reference.

Embodiments of the present invention that are described herein offer an alternative solution, in which host computers are able to interact with a peripheral device on the peripheral component bus of the DPU using standard bus transactions. The interaction is transparent to the host computer, as though the peripheral device were connected directly to the peripheral component bus of the host computer rather than to the DPU. Translation of transaction parameters is carried out by switching logic in the DPU and does not require software-based emulation (although it can be integrated with emulation to offer additional device capabilities to the host computer).

In the disclosed embodiments, address ranges on the host peripheral component bus are allocated to selected functions of a peripheral device or devices attached to the DPU. When bus commands are issued by software running on the host computer to these address ranges on the host bus, the commands are “tunneled” transparently through the root complex of the DPU, with appropriate conversion of the bus addresses and identifiers, to destination devices on the peripheral component bus of the DPU. Responses from the devices are tunneled back to the peripheral component bus of the host computer in similar fashion. By appropriate reservation of address ranges on the peripheral component bus of the host computer, it is also possible to enable the host computer to access devices that have been hot-plugged into the peripheral component bus of the host computer.

The embodiments that are described hereinbelow provide computing apparatus, such as a DPU, which comprises a central processing unit (CPU) and a root complex. The root complex is connected both to the CPU and to a peripheral component bus of the DPU, which has downstream ports for connection to peripheral devices. In addition, the DPU comprises switching logic, which is connected to the CPU and root complex of the DPU and has one or more upstream ports for connection to downstream ports on the peripheral component buses of one or more host computers (and is thus also in communication with the root complex of the host computer). When a peripheral device is connected to a downstream port on the peripheral component bus of the DPU, the switching logic can be configured to present the peripheral device to the host computer in the address space of the peripheral component bus of the host computer.

The switching logic typically comprises a virtual switch, which may be programmed in software to expose either physical functions or virtual functions, or both, of the peripheral devices on the bus of the DPU to the host computer. The switching logic may have multiple upstream ports, for connection to downstream ports on the peripheral component buses of multiple host computers, and may be programmed to assign different functions of the same peripheral device to different host computers. Each function has its own address range (BAR), which is translated by the switching logic to a corresponding address range on the peripheral component bus of the host computer to which it has been assigned.

### System Description

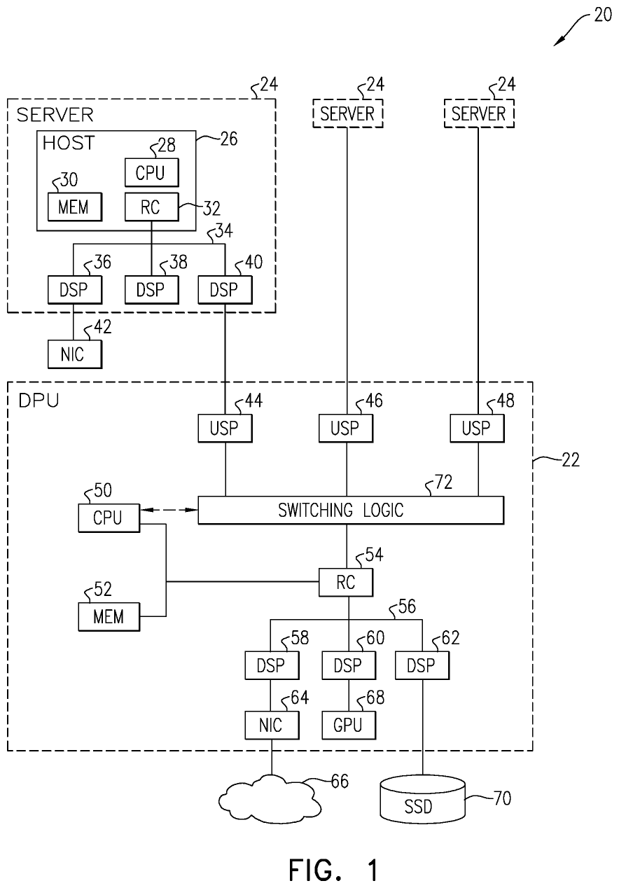

FIG. 1 is a block diagram that schematically illustrates a computer system 20, in accordance with an embodiment of the invention. System 20 comprises a DPU 22, which supports transparent tunneling of root complex functionality for one or more servers 24.

Each server 24 comprises a host computer 26, which includes a CPU 28 and a memory 30. A root complex (RC) 32 in host computer 26 connects to a local peripheral component bus, such as a PCIe bus 34, having multiple downstream ports (DSPs) 36, 38, 40. In the pictured example, DSP 36 connects directly to a local peripheral device, such as a NIC 42 that serves server 24. DSP 40, on the other hand, connects to an upstream port (USP) 44 of DPU 22. Other USPs 46, 48 of DPU 22 connect to downstream ports on other servers 24.

DPU 22 comprises a CPU 50 and a memory 52, along with its own root complex (RC) 54, which connects to a PCIe bus 56 of DPU 22. PCIe bus 56 comprises multiple DSPs 58, 60, 62 for physical connection to respective endpoints. In the pictured example, DSP 58 connects to a NIC 64, which is connected to a packet network 66; DSP 60 connects to a GPU 68; and DSP 62 connects to an SSD 70. RC 54 presents the devices on PCIe bus 56 to CPU 50 in the native address space of the PCIe bus, thus enabling CPU 50 to access the peripheral devices directly. CPU 50 may perform device emulation functions on behalf of servers 24, such as the functions described in the above-mentioned U.S. Patent Application Publication 2022/0309019, but these functions are beyond the scope of the present description.

Switching logic 72 in DPU 22 connects to USPs 44, 46, 48 and to RC 54, so as to enable servers 24 to access the functions of the peripheral devices on PCIe bus 56, such as NIC 64, GPU 68, and/or SSD 70. For this purpose, switching logic 72 functions as a virtual switch, which is configured in software by CPU 50. In this respect, switching logic 72 appears to host computer 26 to be a PCIe switch, having USP 44 connected to DSP 40 and virtual downstream ports exposing the physical and/or virtual functions of one or more of the actual, physical endpoints on PCIe bus 56.

Switching logic 72 tunnels bus transactions received through USP 44 to bus 56, and similarly tunnels bus transactions from bus 56 through to USP 44. This tunneling functionality is carried out in real time by the switching logic, using tables to translate the bus addresses and the Bus Device Function (BDF) indicators between PCIe bus 34 of host computer 26 and PCIe bus 56 of DPU 22. The tables can be programmed individually for each peripheral device function that is exposed by DPU 22 to servers 24. Details of these tables are described hereinbelow.

Although PCIe buses 34 and 56 in FIG. 1 have simple, flat topologies for the sake of simplicity, the principles of the present embodiments may similarly be applied to buses comprising multiple levels of switches and endpoints. Furthermore, although the present embodiments relate, for the sake of clarity, specifically to PCIe buses, the principles of the present invention are similarly applicable, mutatis mutandis, to peripheral component buses of other types. All such alternative embodiments and configurations are considered to be within the scope of the present invention.

### Tunneling Configurations

When a peripheral device is physically connected to a PCIe bus, it exposes at least one physical function (PF) and may expose one or more virtual functions (VFs). The PF enables a host computer to control a wider range of capabilities of the peripheral device, such as single root input/output virtualization (SR-IOV) and power management, while the VFs provide access to only a narrower range of functionalities. In embodiments of the present invention, switching logic 72 can expose the PF and VFs to host computer 26 in different combinations, as illustrated in the figures that follow.

The functions of each peripheral device on bus 56 of DPU 22 are exposed to root complex 54 during the host enumeration phase of the bootup of DPU 22. (Each such peripheral device is referred to as an endpoint, or EP.) Software running on CPU 50 builds the configuration space of bus 56, including assigning a local BDF and BAR to each of the functions of each of the endpoints on bus 56. For some purposes, such as implementation of SR-IOV, the addresses of the VFs of a given endpoint may be separated by a specified, fixed stride. The configuration space also defines the capabilities of each function and indicates to switching logic 72 which functions and capabilities are available for tunneled use by servers 24 via USP 44, 46 or 48. Different functions of the same endpoint on bus 56 may be exposed to different servers 24 via the respective USPs, so that the servers can share the functions of a given peripheral device.

Host computer 26 on server 24 carries out its own host enumeration process and thus builds the configuration space of its own bus 34. As a part of this process, functions exposed by switching logic 72 through the corresponding USP 44, 46 or 48 are also enumerated, and host computer 26 assigns a BAR to each function. Switching logic 72 may also expose a dummy function to host computer 26, which causes the host computer to reserve a BAR for the dummy function. This reserved BAR can later be used to make space to access hot-plugged devices on bus 34 of server 24, by “unplugging” the dummy device.

In the configuration space of bus 34, the capabilities of the tunneled functions may be identical to those of the corresponding functions on bus 56, or they may be different. For example, as illustrated in the examples described below, the PF of a given EP may or may not be tunneled together with the VFs. As another example, a given VF on bus 56 may be exposed on bus 34 as though it were a PF. When the PF is tunneled to bus 34, certain capabilities of the PF, for example power management, may be masked so that host computer 26 is unable to interact with these capabilities. Additionally or alternatively, the VFs of a given endpoint may offer capabilities that the actual, peripheral device does not offer but rather are emulated by software running on DPU 22. For example, an SSD that is physically configured to support a given storage protocol may receive and return data from and to host computer 26 by emulation of a different storage protocol.

After the tunneled version of a given function (PF or VF) on bus 56 has been enumerated and configured in RC 32 of bus 34, CPU 50 issues an “Engage Device” command to instruct switching logic 72 to begin tunneling transactions between host computer 26 and the corresponding EP on bus 56. As part of this process, CPU 50 builds translation tables in the memory of switching logic 72 to enable the switching logic to translate bus commands and responses on the fly between the address spaces of buses 34 and 56. Other tables are built ad hoc per transaction. Simplified examples of these tables and their use are presented below.

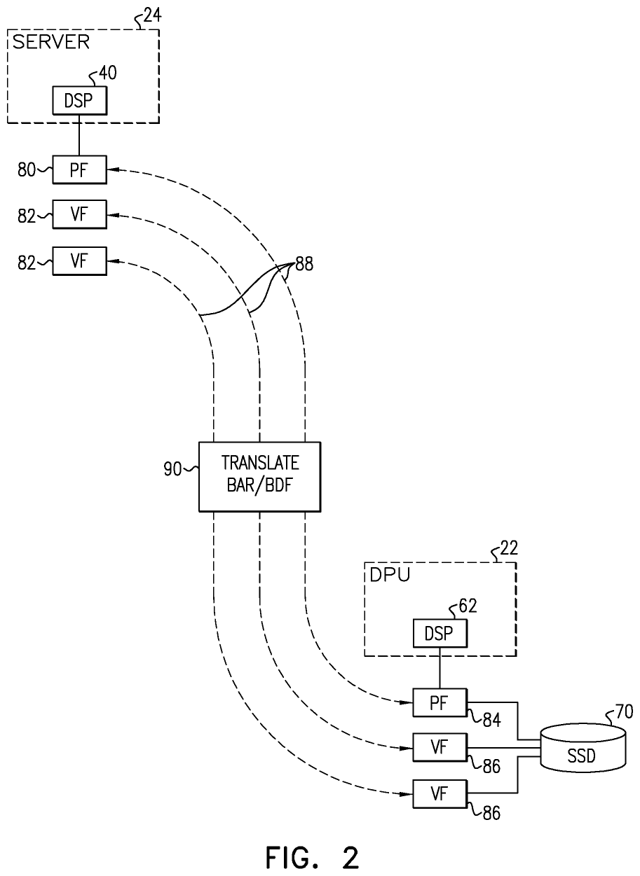

FIG. 2 is a block diagram that schematically illustrates a method for interconnection of functions of a peripheral device on bus 56 of DPU 22 to corresponding functions on bus 34 of server 24, in accordance with an embodiment of the invention. In this example, the peripheral device serving as the physical endpoint (EP) on bus 56 is assumed to be SSD 70; but the principles of this and the subsequent examples are similarly applicable to other types of peripheral devices.

In the pictured example, SSD 70 exposes a PF 84 and multiple VFs 86 via DSP 62 on bus 56 of DPU 22. All these functions are exposed fully to server 24, which configures a corresponding PF 80 and VFs 82 on bus 34 via DSP 40. In the course of the enumeration, configuration, and “Device Engage” processes described above, CPU 50 of DPU 22 configures translation tables 90 in switching logic 72 for the respective BARs of PF 80 and VFs 82. (Alternatively, when there is a fixed stride between multiple VFs within a single BAR, as is used in SR-IOV configurations, a single translation table may be used for all these VFs in each direction of communication.) Translation tables 90 enable switching logic 72 to implement tunnels 88 between PFs 80 and 84 and between VFs 82 and 86. Thus, server 24 is able to control and interact with SSD 70 as though the SSD was physically attached to DSP 40.

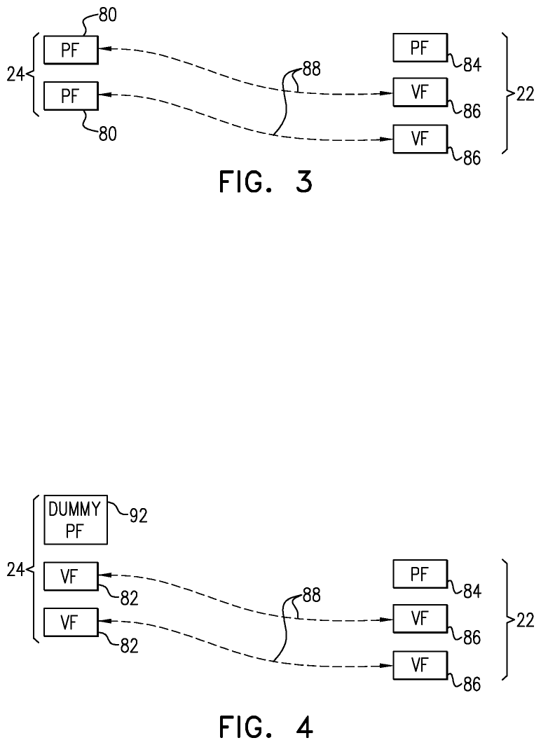

FIG. 3 is a block diagram that schematically illustrates a method for interconnection of functions of a peripheral device on bus 56 of DPU 22 to corresponding functions on bus 34 of server 24, in accordance with another embodiment of the invention. In this case, PF 84 on bus 56 of DPU 22 is not exposed to server 24, so that DSP 22 maintains control of the actual PF 84 of the endpoint. Switching logic 72 exposes VFs 86 as though they were individual PFs of different physical endpoints. Server 24 configures corresponding PFs 80 on bus 34, connected by tunnels 88 to VFs 86.

FIG. 4 is a block diagram that schematically illustrates a method for interconnection of functions of a peripheral device on bus 56 of DPU 22 to corresponding functions on bus 34 of server 24, in accordance with yet another embodiment of the invention. In this case, too, PF 84 on bus 56 of DPU 22 is not exposed to server 24, and VFs 86 of the physical endpoint on bus 56 are connected by tunnels 88 to corresponding VFs 82 on bus 34. Since PCIe convention requires that a PF be present on the bus for each connected device, VFs 82 are accompanied by a dummy PF 92, which is not tunneled to any active function on bus 56.

The following tables are simplified examples of translation tables 90 used by switching logic 72 in translating PCIe transaction layer packets (TLPs) received by DPU 22 from host computer 26 for transmission on bus 56 (Table I) and TLPs sent from DPU 22 to host computer 26 for transmission on bus 34 (Table II). The tables are followed by several examples illustrating typical bus transactions carried out through switching logic 72 using the tables. In these examples, the tables are assumed to be used for accessing bus addresses in the BAR 0x100000-0x101000 on bus 34.

TABLE I
ADDRESS TRANSLATION - HOST TO PHYSICAL EP

| Field | Description | Value | Configuration |
|---|---|---|---|
| region_io | Set if the tunnel | 0 | Communicated by |
| | represents IO | | DPU SW during |
| | BAR, cleared if it | | “Engage Device” |
| | represents | | command. |
| | Memory BAR. | | |
| region_start_addr[63:12] | Stores the BAR | 0x200000 | Communicated by |
| | that was assigned | | DPU SW during |
| | by the DPU to the | | “Engage Device” |
| | EP. | | command. |
| | When Host | | |
| | initiates Memory | | |
| | Request to the | | |
| | DPU Peripheral | | |
| | Device, the | | |
| | Address field in | | |
| | TLP will be | | |
| | translated using | | |
| | this field as base. | | |
| emu_space_reqid[15:0] | Stores the BDF of | 02:00.0 | Known during |
| | the root port in | | DPU |
| | DPU domain. | | enumeration. |
| | When Host | | |
| | initiates Memory | | |
| | Request to the | | |
| | DPU Peripheral | | |
| | Device, the | | |
| | ‘RequesterID’ field | | |
| | in TLP will be | | |
| | replaced by this | | |
| | field. | | |
| func_bar_log_size[5:0] | Reflects the size | 1 Kb | Communicated by |
| | of the BAR. | | DPU SW during |
| | | | “Engage Device” |
| | | | command. |
| num_of_func[1:0] | Reflects the | 1 | Communicated by |
| | number of | | DPU SW during |
| | Functions in DPU | | “Engage Device” |
| | domain that are | | command. |
| | engaged to the | | |
| | Host. | | |

TABLE II
ADDRESS TRANSLATION - PHYSICAL EP TO HOST

| Field | Description | Value | Configuration |
|---|---|---|---|
| host_pid[2:0] | The USP to which the | Host#1 | Communicated by |
| host_lid[2:0] | Host is connected. | | DPU SW during |
| | | | “Engage Device” |
| | | | command. |
| dest_bdf[15:0] | Holds the BDF of the | 02:00.0 | Known during Host |
| (xlated_bdf) | root port in Host | | enumeration. |
| | domain. | | |
| | When Physical EP | | |
| | initiates Message- | | |
| | Routed-by-BDF, the | | |
| | ‘BDF’ field in TLP will | | |
| | be replaced by this | | |
| | field. | | |
| emu_requested_id[15:0] | Holds the BDF of the | 01:00.0 | Communicated by |
| (xlated_requester_id) | DPU Peripheral | | DPU SW during |
| | Function in the Host | | “Engage Device” |
| | domain. | | command. |
| | When Physical EP | | |
| | initiates transaction, | | |
| | the ‘RequesterID’ field | | |
| | in TLP will be replaced | | |
| | by this field. | | |
| num_of_func[15:0] | Reflects the number of | 1 | Communicated by |
| | Functions in DPU | | DPU SW during |
| | domain that are | | “Engage Device” |
| | engaged to the Host. | | command. |

### EXAMPLE I—HOST TO EP WRITE

### Original TLP on Bus 34

Type: WRITE
BAR address: 0x100004
RequesterID: 11:00.0 (Host #1 CPU)
Data: 0xDEADBEAF

The BAR address is translated using the base address of the range (0x100000) and the region_start_addr field from Table I. The Requester ID is translated using the BDF provided by the emu_space_reqid field in Table I. The resulting translated TLP is as follows:

### Translated TLP on Bus 56

Type: WRITE
BAR address: 0x100004−0x100000+0x200000=0x200004
RequesterID: 12:00.0
Data: 0xDEADBEAF
   (In this example, the value “12:00.0” is globally configured as the Requester ID of root complex 54.)

### EXAMPLE II—HOST TO EP READ

In response to a read request from host computer 26, switching logic 72 creates a temporary context table (shown below as Table III), which it then uses in completing the read transaction by sending data to the host computer.

### Original TLP on Bus 34

Type: READ
BAR address: 0x100004
RequesterID: 11:00.0
Tag=0xA

### Translated TLP on Bus 56

Type: READ
BAR address: 0x100004−0x100000+0x200000=0x200004
RequesterID: 12:00.0
Tag=0xB (read from a pool of free tags)

TABLE III
READ CONTEXT TABLE

| Field | Value |
|---|---|
| Original tag | 0xA |
| Original Req ID | 11:00.0 |
| Orig. Completer ID | 01:00.0 |

In response to the translated read TLP, SSD 70 will return a completion TLP over bus 56 with Requester ID 12:00.0 and Tag 0xB. Switching logic 72 uses Tables II and III in generating a translated TLP for transmission over bus 34:

### Original TLP on Bus 56

Type: Completion
RequesterID: 12:00.0
CompleterID: 02:00.0
Tag=0xB
Data=0xDEADBEAF

### Translated TLP on Bus 34

Type: Completion
Requester ID: 11:00.0
CompleterID: 01:00.0
Tag=0xA
Data=0xDEADBEAF

After completion of the transaction, the context table is deleted.

### EXAMPLE III—HOST TO EP WRITE

Switching logic 72 performs the following translation using the BDF provided by the emu_requested_id field in Table II:

### Original TLP on Bus 56

Type: WRITE
RequesterID: 02:00.0
Address=0x80000

### Translated TLP on Bus 34

Type: WRITE
RequesterID: 01:00.0
Address=0x80000

### EXAMPLE IV—EP TO HOST READ

In response to a read request from SSD 70, switching logic 72 creates a temporary context table (shown below as Table IV), which it then uses in completing the read transaction by conveying data from host computer 26 to SSD 70.

### Original TLP on Bus 56

Type: READ
RequesterID: 02:00.0
Address: 0x80000
Tag=0xA

### Translated TLP on Bus 34

Type: READ
RequesterID: 01:00.0
Address: 0x80000
Tag=0xB

TABLE IV
READ CONTEXT TABLE

| Field | Value |
|---|---|
| Original tag | 0xA |
| Original Req ID | 02:00.0 |
| Orig. Completer ID | 12:00.0 |

In response to the translated read TLP, host computer 26 will return a completion TLP over bus 34 with Requester ID 02:00.0 and Tag 0xB. Switching logic 72 uses Tables I and IV in generating a translated TLP for transmission over bus 56:

### Original TLP on Bus 34

Type: Completion
RequesterID: 01:00.0
CompleterID: 11:00.0
Tag=0xB
Data=0xDEADBEAF

### Translated TLP on Bus 56

Type: Completion
Requester ID: 02:00.0
CompleterID: 12:00.0
Tag=0xA
Data=0xDEADBEAF

After completion of the transaction, the context table is deleted.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Computing apparatus, comprising:
a central processing unit (CPU);
a root complex connected to the CPU and to a first peripheral component bus, which has at least a first downstream port for connection to at least one peripheral device; and
switching logic, which has an upstream port for connection to a second downstream port on a second peripheral component bus of a host computer, and which is connected to the root complex so that when a peripheral device is connected to the first downstream port on the first peripheral component bus, the switching logic presents the peripheral device to the host computer in an address space of the second peripheral component bus.

2. The apparatus according to claim 1, wherein the switching logic comprises a virtual switch.

3. The apparatus according to claim 1, wherein the switching logic is to present the peripheral device as a physical function in the address space of the second peripheral component bus.

4. The apparatus according to claim 3, wherein the peripheral device is to expose a virtual function on the first peripheral component bus, and the switching logic is to present the virtual function as the physical function in the address space of the second peripheral component bus.

5. The apparatus according to claim 1, wherein the switching logic is to present the peripheral device as a virtual function in the address space of the second peripheral component bus.

6. The apparatus according to claim 1, wherein the peripheral device comprises a data storage device.

7. The apparatus according to claim 1, wherein the peripheral device comprises a network interface controller (NIC).

8. The apparatus according to claim 1, wherein the address space of the second peripheral component bus is a second address space, and wherein the root complex is to present the peripheral device to the CPU in a first address space of the first peripheral component bus.

9. The apparatus according to claim 8, wherein the switching logic is to receive a bus transaction via the upstream port referencing the second address space of the second peripheral component bus and directed to the peripheral device, to translate the bus command to the first address space, and to transmit the translated bus command over the first peripheral component bus.

10. The apparatus according to claim 1, wherein the switching logic is to reserve a segment of the address space for a dummy device, to enable hot-plugging of a further peripheral device in the reserved segment.

11. A method for computing, comprising:
providing a peripheral device server comprising a root complex connected to a first peripheral component bus;
connecting a peripheral device to a first downstream port on the first peripheral component bus;
connecting an upstream port of the peripheral device server to a second downstream port on a second peripheral component bus of a host computer; and
using switching logic in the peripheral device server coupled between the upstream port and the first downstream port, presenting the peripheral device to the host computer in an address space of the second peripheral component bus.

12. The method according to claim 11, wherein the switching logic comprises a virtual switch coupled between the upstream port and the first downstream port.

13. The method according to claim 11, wherein presenting the peripheral device comprises exposing the peripheral device as a physical function in the address space of the second peripheral component bus.

14. The method according to claim 13, wherein coupling the peripheral device comprises exposing a virtual function of the peripheral device on the first peripheral component bus, and wherein exposing the peripheral device comprises presenting the virtual function as the physical function in the address space of the second peripheral component bus.

15. The method according to claim 11, wherein presenting the peripheral device comprises exposing the peripheral device as a virtual function in the address space of the second peripheral component bus.

16. The method according to claim 11, wherein the peripheral device comprises a data storage device.

17. The method according to claim 11, wherein the peripheral device comprises a network interface controller (NIC).

18. The method according to claim 11, wherein the address space of the second peripheral component bus is a second address space, and wherein the root complex is to present the peripheral device to a CPU of the peripheral device server in a first address space of the first peripheral component bus.

19. The method according to claim 18, and comprising receiving, by the switching logic, a bus transaction via the upstream port referencing the second address space of the second peripheral component bus and directed to the peripheral device, translating the bus command to the first address space, and transmitting the translated bus command over the first peripheral component bus.

20. The method according to claim 11, and comprising reserving a segment of the address space for a dummy device, to enable hot-plugging of a further peripheral device in the reserved segment.
